(19) United States
(12) Patent Application Publication
(10) Pub. No.: US 2026/0178566 A1
(43) Pub. Date: Jun. 25, 2026

(54) APPARATUS AND METHOD FOR COMPRESSING BLOCKCHAIN ROLLUP TRANSACTION DATA

(71) Applicant: ELECTRONICS AND TELECOMMUNICATIONS RESEARCH INSTITUTE, Daejeon (KR)

(72) Inventor: Changhyun LEE, Daejeon (KR)

(73) Assignee: ELECTRONICS AND TELECOMMUNICATIONS RESEARCH INSTITUTE, Daejeon (KR)

(21) Appl. No.: 19/426,877

(22) Filed: Dec. 19, 2025

(30) Foreign Application Priority Data
Dec. 20, 2024 (KR) 10-2024-0192588

(51) Int. Cl. G06F 16/23; G06F 16/21

(52) U.S. Cl. CPC G06F 16/2379; G06F 16/212

(57) ABSTRACT

Disclosed herein are an apparatus and method for compressing blockchain rollup transaction data. An apparatus for compressing blockchain rollup transaction data groups a plurality of lower layer transaction data items into a single batch on blockchain, searches pre-generated dictionary data by using a field value included in the single batch as a key, substitutes the field value with an entry value searched from the dictionary data, and generates upper layer transaction data by compressing the single batch substituted with the entry value.

### CROSS REFERENCE TO RELATED APPLICATION

This application claims the benefit of Korean Patent Application No. 10-2024-0192588, filed Dec. 20, 2024, which is hereby incorporated by reference in its entirety into this application.

### BACKGROUND OF THE INVENTION

### 1. Technical Field

The present disclosure relates to a blockchain rollup technology, and more particularly to a blockchain rollup transaction data compression technology.

### 2. Description of the Related Art

A blockchain is a distributed ledger that processes user-submitted transactions and stores the records in an append-only manner, operating on a decentralized distributed node basis. In the process of processing and storing transactions, a blockchain node uses a computer's CPU, memory and disk, and the resulting costs are covered by the user in the form of a transaction fee. Furthermore, due to the use of consensus protocols to maintain security during the transaction processing, transaction processing speed is more constrained than a centralized ledger.

As of 2024, the Ethereum blockchain's ledger size is approximately 1,100 GB, demanding massive disk resources from participating nodes, and the average transaction fee is also high around 1 dollar. On the other hand, the Ethereum's transaction processing speed remains low at about 12 TPS. These high cost and low speed are important factors that inhibit the proliferation of blockchain services.

To address these limitations of existing blockchains, blockchain rollups are a technology that has recently been spotlighted. In blockchain rollups, transaction execution is handled on a lower layer (Layer 2), while only compressed transaction data and a summary of the execution results are submitted to the upper layer (Layer 1), the base blockchain. This allows transactions to be processed more quickly and at a lower cost. Ethereum is a representative Layer 1 blockchain that employs rollup technology, and Layer 2 blockchains operating in a lower layer of Ethereum include Arbitrum, Optimism, zkSync, etc.

Currently, to transmit layer 2 transaction data processed on a layer 2 blockchain to a layer 1 blockchain, a procedure is repeatedly performed in which multiple transactions are grouped into a batch, the volume of the batch is reduced using a universal data compression algorithm such as zlib, and a single layer 1 transaction containing the batch data is generated and submitted to the layer 1 blockchain. In this case, as the volume of the batch data is reduced by compressing the batch data, the number of layer 2 transactions to be contained in the layer 1 transaction increases, which leads to a reduction in layer 2 transaction fee and an increase in transaction processing speed. However, in the current structure, to compress the batch, only the transaction data within the single batch being processed at the time is referenced, depending solely on the limited performance of the compression algorithm being used.

In the meantime, PCT published patent application PCT 2022-117435 entitled “Methods and systems for compressing transaction identifiers” discloses a method of compressing and restoring a transaction identifier (TxID) field among blockchain transaction fields.

### SUMMARY OF THE INVENTION

Accordingly, the present disclosure has been made keeping in mind the above problems occurring in the prior art, and an object of the present disclosure is to reduce the size of a batch by further compressing the batch than the existing technique when a plurality of layer 2 transactions are grouped into the batch and submitted to the layer 1 blockchain in blockchain rollups.

Another object of the present disclosure is to gain effects of saving disk space, reducing transaction fees, and increasing transaction processing speed by increasing the compression ratio of transaction strings.

In accordance with an embodiment of the present disclosure to accomplish the above objects, there is provided an apparatus for compressing blockchain rollup transaction data, including one or more processors and a memory configured to store at least one program that is executed by the one or more processors, wherein the at least one program is configured to group a plurality of lower layer transaction data items into a single batch on a blockchain, search pre-generated dictionary data by using a field value included in the single batch as a key, substitute the field value with an entry value searched from the dictionary data, and generate upper layer transaction data by compressing the single batch substituted with the entry value.

The at least one program may be further configured to, when the field value exists in the dictionary data, substitute the field value with an entry of the dictionary data, the entry including a block number and a transaction index of a transaction in which the field value previously occurred.

The at least one program may be configured to, when the field value does not exist in the dictionary data, add a new entry value.

The at least one program may be configured to use the field value as a key and add a value resulting from combining the transaction's block number and index as the new entry value.

The at least one program may be configured to, when a ‘to’ field value exists in the dictionary data, substitute the current ‘input’ field value with a combination of a block number, a transaction index corresponding to a prior occurrence of the ‘to’ field value, and a compressed string.

The at least one program may be configured to, when no ‘to’ field value of the transaction exists in the dictionary data, add the new entry in which a key is a ‘to’ field value and a value is a combination of a block number, a transaction index and an ‘input’ field value.

In accordance with another aspect of the present disclosure to accomplish the above objects, there is provided a method for compressing blockchain rollup transaction data, including grouping a plurality of lower layer transaction data items into a single batch on a blockchain; searching pre-generated dictionary data by using a field value included in the single batch as a key; substituting the field value with an entry value searched from the dictionary data; and generating upper layer transaction data by compressing the single batch substituted with the entry value.

The substituting may include substituting the field value, when the field value exists in the dictionary data, with an entry of the dictionary data, the entry including a block number and a transaction index of a transaction in which the field value previously occurred, the transaction index indicating a position of the transaction within a block.

The substituting may include, when the field value does not exist in the dictionary data, add a new entry value.

The substituting may include using the field value and adding a value resulting from combining the transaction's block number and transaction index as the new entry value.

The substituting may include using the field value and adding a value resulting from combining the transaction's block number and transaction index as the new entry value.

The substituting may include, when a ‘to’ field value exists in the dictionary data, substituting the current ‘input’ field value with a combination of a block number, a transaction index corresponding to a prior occurrence of the ‘to’ field value, and a compressed string.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an operation flowchart illustrating a method for compressing blockchain rollup transaction data according to an embodiment of the present disclosure;

FIG. 2 is an operation flowchart illustrating a procedure for dictionary entry generation and field substitution for exact match substitution according to an embodiment of the present disclosure;

FIG. 3 is an operation flowchart illustrating a procedure for dictionary entry generation and field substitution for a close match based ‘input’ field according to an embodiment of the present disclosure; and

FIG. 4 is a diagram illustrating a computer system according to an embodiment of the present disclosure.

### DESCRIPTION OF THE PREFERRED EMBODIMENTS

The present disclosure will be described in detail with reference to the attached drawings. Repeated descriptions and descriptions of known functions and configurations which have been deemed to make the gist of the present disclosure unnecessarily obscure will be omitted below. The embodiments of the present disclosure are provided to more fully describe the present disclosure to those skilled in the art. Therefore, the shapes, sizes, etc. of elements in the drawings may be exaggerated for clear illustration.

In the entire specification, when a certain element is described as “comprising” or “including” a specific component, it means that, unless explicitly stated otherwise, the certain element may further include additional components without excluding the additional components.

The present disclosure may be variously modified and may have various embodiments, and the embodiments are intended to be illustrated and described in detail in the accompanying drawings.

However, this is not intended to limit the present disclosure to particular embodiments, and it should be appreciated that all changes, equivalents, and substitutes that do not depart from the spirit and technical scope of the present disclosure are encompassed in the present disclosure.

In description of components of the embodiment of the present disclosure, terms such as first, second, A, B, (a), and (b) may be used. These terms are used merely to distinguish one component from other components, and the essentials, order, or sequence of the components are not limited by the terms.

Unless otherwise defined, all terms including technical and scientific terms used herein have the same meaning as commonly understood by one of ordinary skill in the art to which the present disclosure belongs. Terms that are generally defined in commonly used dictionaries should be construed as having meanings consistent with their contextual usage in the relevant technical field, and, unless explicitly defined in this application, and should not be construed in an idealized or unduly formal sense.

It will be understood that when a component is referred to as being “associated” with another component, it can be directly associated with or connected to the other component, but other intervening components may be present therebetween.

The terms used in the present disclosure are used only to describe a specific embodiment, and are not intended to limit the present disclosure. A singular expression includes a plural expression unless a description to the contrary is specifically pointed out in context. It will be further understood that the terms “comprise”, “include”, “have”, etc. when used in this specification, specify the presence of stated features, numbers, steps, operations, elements, or combinations thereof but do not preclude the possibility of the presence or addition of one or more other features, numbers, steps, operations, elements, or combinations thereof.

Hereinafter, embodiments of the present disclosure will be described in detail with reference to the attached drawings. In the description of the present disclosure, independent reference numerals are used to designate the same components in the drawings to facilitate overall understanding.

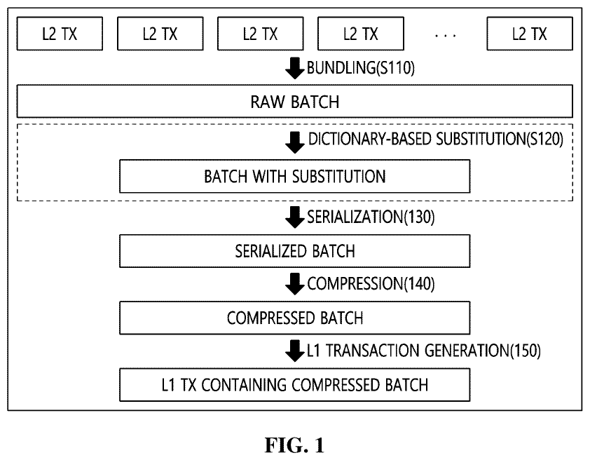

FIG. 1 is an operation flowchart illustrating a method for compressing blockchain rollup transaction data according to an embodiment of the present disclosure.

Referring to FIG. 1, in the method for compressing blockchain rollup transaction data, a plurality of layer 2 transactions (or L2 Txs) may go through the steps of bundling, substitution, serialization, and compression, and may be transformed into a transaction to be submitted to layer 1.

The present disclosure proposes a compression technique that attains a higher compression ratio than in the batch compression method currently adopted in blockchain rollups by considering the fact that general compression algorithms has a higher compression ratio as the string contains many repeated characters and that there are many repeated characters even between transactions belonging to different batches on the Layer 2 blockchain.

In an embodiment of the present disclosure, the method for compressing blockchain rollup transaction data may begin with bundling at step S110.

Specifically, at step S110, bundling may be performed to group the plurality of L2 Txs into a single batch.

This may save transmitting and storing costs in the network by grouping the individual transactions for efficient processing at step S110.

In an embodiment of the present disclosure, in the method for compressing blockchain rollup transaction data, dictionary-based substitution may be performed at step S120.

Specifically, at step S120, dictionary-based substitution to perform additional data compression by making the most of redundant strings between different batches may be performed.

Step S120 may be performed selectively before and after serialization at step S130 depending on the operating environment, but it is assumed to be performed before serialization at step S130 in the present disclosure.

In this case, step S120 may include using dictionary data made in the form of mapping between keys and field values, searching the dictionary data with a current value as a key for each field (from, gas, gasPrice, input, nonce, to, v, r, s, or the like) that makes up the layer 2 transaction data, and substituting the current value with a field value corresponding to the key when there is an exact match or close match for the key.

For example, at step S120, when the current value of a ‘to’ field indicating a destination address is ‘0x7Eb2048d69E6E03BbA9CfFd9be16DAb26dE925cE’ and there is a (key, value) entry of the dictionary search result (0x7Eb2048d69E6E03BbA9CfFd9be16DAb26dE925cE, XYZ), the value of the ‘to’ field may be substituted with XYZ. As the frequency of substituting field values of transactions with shorter strings increases, the batch size may be further reduced, and the original data may be losslessly restored later by using the entries of the dictionary in reverse. The dictionary used for substitution may be generated in real time in the process of handling layer 2 transactions, and may be cumulatively maintained from the first time the layer 2 blockchain activates to use redundant strings between the different batches.

In an embodiment of the present disclosure, the method for compressing blockchain rollup transaction data may include serializing the single batch at step S130.

Specifically, at step S130, the single batch may be transformed into a continuous byte stream through serialization.

In this case, transaction data may be transformed into a form of a continuous byte stream at step S130.

At step S130, the serialized data may be optimized to reduce the size.

For example, at step S130, a serialization technique widely used on blockchain such as RLP encoding may be used.

Furthermore, in an embodiment of the present disclosure, the method for compressing blockchain rollup transaction data may include compressing the serialized batch at step S140.

Specifically, at step S140, the serialized batch data may be compressed to reduce the data size to an optimized form.

For example, when a compression algorithm such as zlib or brotli that removes unnecessary blank spaces or redundant patterns from the serialized data at step S140, transaction processing costs and storage space may be significantly reduced.

Moreover, in an embodiment of the present disclosure, the method for compressing blockchain rollup transaction data may include generating layer 1 transaction (L1 Tx) data at step S150.

Specifically, at step S150, an L1 Tx including the compressed batch may be generated and submitted to be included in a layer 1 blockchain ledger. For example, the generated L1 Tx may ensure efficient and safe recording of the layer 2 transaction data and contribute to reducing blockchain transaction fees and improve processing speed.

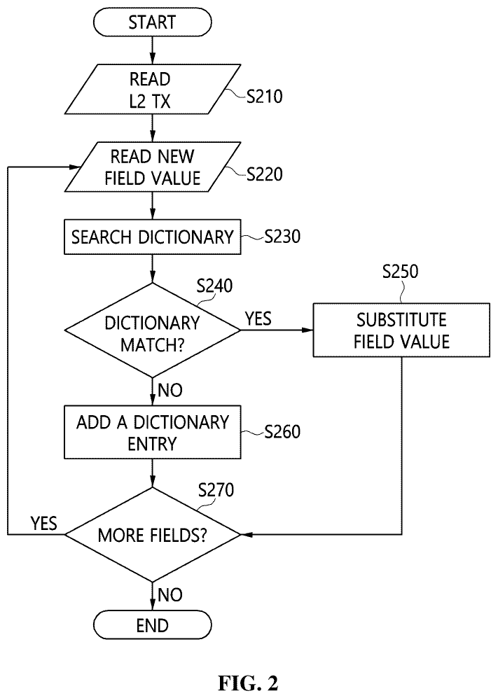

FIG. 2 is an operation flowchart illustrating a procedure for dictionary entry generation and field substitution for exact match substitution according to an embodiment of the present disclosure.

In the case of the batch compressed by using the dictionary-based substitution at step S120 as illustrated in FIG. 1, there may be a drawback of a burden on additional storage capacity and network bandwidth to use the layer 1 blockchain or a separate channel to receive the entire dictionary information used for substitution to decompress the batch and restore the original data in another node instead of the node that has performed the compression. To solve this problem, the present disclosure proposes both dictionary entry generation and restoration methods, by which the original data may be restored even without transmitting the entire dictionary information.

Referring to FIG. 2, as an example of the dictionary-based substitution at step S120 illustrated in FIG. 1, illustrated is a detailed procedure for substituting a field value with a dictionary entry value corresponding to an exact match or generating a new dictionary entry.

At step S210, L2 transaction (L2 Tx) data may be read out.

For example, at step S210, preparation for processing field values may be made by sequentially reading out one of multiple transaction data items.

At step S220, a new specific field value of the transaction data currently being read may be read out.

For example, at step S220, when the ‘to’ field value of the transaction is ‘0xe688b84b23f322a994a53dbf8e15fa82cdb71127’, the value is taken to be used later for dictionary search or substitution tasks.

At step S230, the dictionary may be searched with the read-out field value as the key.

For example, at step S230, the dictionary data in the memory may be searched to check whether the field value already exists in the dictionary.

At step S240, whether the key exists in the dictionary may be determined as a result of the dictionary search.

In this case, when an entry matching the field value exists in the dictionary at step S240, the field value may be substituted with the entry value of the dictionary at step S250.

For example, at step S250, in the case that the field value exists in the dictionary, the original field value may be substituted with a value like #(block number) #(transaction index).

In this case, after substitution, the field value may be represented in the format #(block number) #(transaction index), which is a combination of a block number of a block in which the field value previously occurred and a transaction index indicating a position of the transaction within the block.

Furthermore, when no entry matching the field value exists in the dictionary at step S240, a new entry may be added at step S260.

Specifically, at step S260, a key that does not exist in the dictionary may be added as the new entry. For example, at step S260, the field value may be used as the key, and a value resulting from combining the transaction's block number and index may be added as the new entry value.

For example, at step S260, when the ‘to’ field value of the currently read-out transaction is ‘0xe688b84b23f322a994a53dbf8e15fa82cdb71127’, which does not exist in the dictionary, and the current transaction is the 10th transaction in block number 100, a new dictionary entry in the form of (0xe688b84b23f322a994a53dbf8e15fa82cdb71127, #100 #10) may be generated for the dictionary. The # character is used to distinguish the block number and the transaction index, but any character may be used as a delimiter.

At step S260, the dictionary data may be stored in the computer's memory region for fast search, a maximum size of the dictionary data may be set in advance to prevent excessive use of the memory, and the dictionary size may be maintained by deleting the oldest entry or the least frequently used entry in the dictionary when the maximum size is exceeded.

At step S270, whether there is a field to be additionally processed in the current transaction may be checked. For example, when there is another field value left, the next field is processed at step S220, and the procedure may be terminated after all the fields are processed.

As such, processes of efficiently storing and restoring the original data may be sequentially performed through compression and dictionary management of the transaction fields in the respective steps.

Layer 2 blockchain nodes inherently has a feature of synchronizing to and maintaining the latest ledger data, and using this, the compressed batch may be losslessly restored through dictionary-based substitution without a separate dictionary data download. The restoration order may be followed in reverse of the procedure for dictionary entry generation and field substitution for exact match substitution as illustrated in FIG. 2. For example, when the field value of the transaction to be restored is represented by a substituted value like #100 #10, the 10th transaction in block 100 may be found by searching ledger data that a node has, and may restore the original value of the current transaction by using the field value ‘0xe688b84b23f322a994a53dbf8e15fa82cdb71127’ of the transaction.

Compression efficiency may increase by performing substitution only when there are exact matches with entries in the dictionary for most of the layer 2 blockchain transaction fields, the maximum size of which is 32 bytes. Meanwhile, the ‘input’ field for transmitting the function and arguments when a smart contract is executed has no length limit in theory and is often used with a long string. For the fields having these characteristics, substitution may be additionally performed based on a close match.

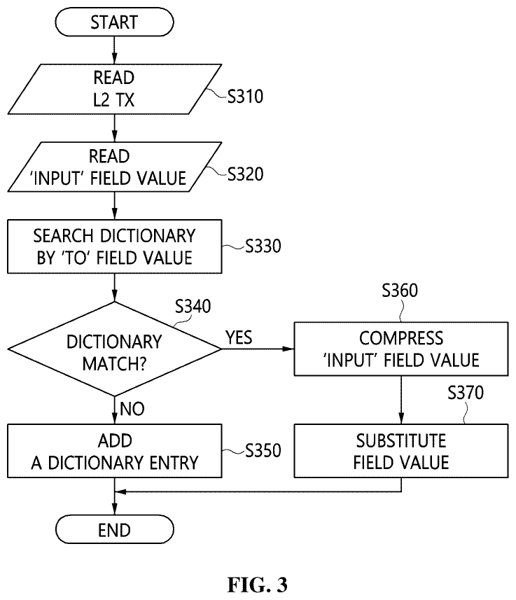

FIG. 3 is an operation flowchart illustrating a procedure for dictionary entry generation and field substitution for ‘input’ fields based on a close match according to an embodiment of the present disclosure.

Referring to FIG. 3, as an example of the dictionary-based substitution at step S120 illustrated in FIG. 1, illustrated is a detailed procedure for substituting a field value with a dictionary entry value corresponding to an exact match or generating a new dictionary entry.

When there are two transactions executing the same function of the same smart contract with different arguments, the values of the ‘input’ field of the transactions are not an exact match but may be seen as having quite similar characteristics. For close match strings instead of exact match strings, direct substitution is not possible, but additional compression may be performed by using the dictionary function of a universal compression algorithm such as brotli, zlib, etc., (for the python zlib library, the zidct setting in the compressobj function).

At step S310, a layer 2 transaction (L2 Tx) may be read out. In this step, a preparation for extracting field values required for the next step may be made by reading out a transaction to be currently processed.

At step S320, a value of the ‘input’ field of the current transaction may be read out. This field value has no limit of length in theory and is often used with a long string, and may be subsequently used for compression and substitution tasks.

To check for the existence of an existing close-match transaction and identify the ‘input’ field value to be referenced for substitution of the ‘input’ field, an extra dictionary may be built and used in addition to the dictionary used for exact matches. A key value of the extra dictionary is a value of the ‘to’ field with consideration for the fact that transactions executing the same smart contract have the same ‘to’ field value and similar ‘input’ field values.

At step S330, the ‘to’ field value of the current transaction may be used as the key to search the dictionary.

At step S330, when having the same ‘to’ field value, the transactions are more likely to execute the same smart contract, so similar features (close matches) of the ‘input’ field values may be identified.

At step S330, to generate a dictionary for the ‘input’ field, when a transaction comes in, whether the transaction is a smart contract execution transaction may be determined and then the dictionary may be searched with the ‘to’ field value as the key.

At step S340, whether the ‘to’ field value exists may be determined as a result of the dictionary search.

When there is no matching entry at step S340, a new dictionary entry may be added at step S350.

At step S350, the new entry may be added with a ‘to’ field value that does not exist in the dictionary as the key.

At step S350, a dictionary entry may be generated with the key being the ‘to’ field value and a value being #(block number) #(transaction index) #(‘input’ field value).

Furthermore, when there is a matching entry at step S340, the current ‘input’ field value may be compressed by using the existing ‘input’ field value in the dictionary as a dictionary input to a universal compression algorithm (brotli, zlib, etc.) at step S360.

At step S360, a compressed string may be generated by using an ‘input’ field value included in field values corresponding to the dictionary entry as a dictionary input to the universal compression algorithm.

For example, at step S360, the compressed string may be generated by using the compressobj function of the python zlib library to designate an old ‘input’ field value input_old as the dictionary input and compressing a current ‘input’ field value input_new.

At step S360, when there is an entry of the key for dictionary search, an ‘input’ field value included in field values corresponding to the entry may be used as the dictionary input to the universal compression algorithm, to generate a compressed string.

At step S370, the current ‘input’ field value may be substituted with #(block number) #(transaction index) #(compressed string).

At step S370, when a value of the ‘to’ field corresponds to a close match, the current ‘input’ field value may be substituted with #(block number) #(transaction index) #(compressed string), where the block number and the transaction index correspond to a prior occurrence of the ‘to’ field value, and the compressed string is generated by compressing the current ‘input’ field value using a universal compression algorithm with an ‘input’ field value stored in the dictionary data for the prior occurrence as dictionary input. For example, the ‘input’ field value of the 11th transaction in block number 101may be represented as virtual data 1 (hereinafter, referred to as input_old).

### Virtual Data 1

0x12aa3caf000000000000000000000000afea5601b0a894451955355e79ad30265 15e500d000000000000000000000000eeeeeeeeeeeeeeeeeeeeeeeeeeeeeeeeeeeeeeee0000 000000000000000000009485aca5bbbe1667ad97c7fe7c4531a624c8b1ed000000000000 000000000000afea5601b0a894451955355e79ad3026515e500d00000000000000000000 0000fcc0f4e049591d3d3b672b5e885d58235d059fcd0000000000000000000000000000 0000000000000000000000009433c0ddbc0000000000000000000000000000000000000 000000000000003650bf071cb8d4d000000000000000000000000000000000000000000 00000000000014000000000000000000000000000000000000000000000000000000000 00000160000000000000000000000000000000000000000000000000000000000000000 000000000000000000000000000000000000000000000000000000000000002fc000000 0000000000000000000000000000000000000000000000000002de00a007e5c0d200000 00000000000000000000000000000000000000002ba00016a00001a4041420000000000 0000000000000000000000000006d0e30db05126a132dab612db5cb9fc9ac426a0cc215a3423f9c942000000000000000000000000000000000000060004f41766d8000000000000 000000000000000000000000000000000000000040c7000000000000000000000000000 000000000000000000000000000000000000a0000000000000000000000000afea5601b0a894451955355e79ad3026515e500d00000000000000000000000000000000000000000 0000000000000006491ad0f000000000000000000000000000000000000000000000000 00000000000000010000000000000000000000004200000000000000000000000000000 0000000060000000000000000000000007f5c764cbc14f9669b88837ca1490cca17c31607 00000000000000000000000000000000000000000000000000000000000000005126a13 2dab612db5cb9fc9ac426a0cc215a3423f9c97f5c764cbc14f9669b88837ca1490cca17c31 6070004f41766d800000000000000000000000000000000000000000000000000000000 000000000000000000000000000000000000000000000000000000000364df00f12d7182 00000000000000000000000000000000000000000000000000000000000000a00000000 000000000000000001111111254eeb25477b68fb85ed929f73a960582000000000000000 000000000000000000000000000000000000000006491ad0f0000000000000000000000 0000000000000000000000000000000000000000010000000000000000000000007f5c7 64cbc14f9669b88837ca1490cca17c316070000000000000000000000009485aca5bbbe16 67ad97c7fe7c4531a624c8b1ed0000000000000000000000000000000000000000000000 00000000000000000000000000a20a9a94

The ‘input’ field value of the currently processed transaction may be represented as virtual data 2 (hereinafter, referred to as input_new).

### Virtual Data 2

0x12aa3caf000000000000000000000000afea5601b0a894451955355e79ad3026 515e500d000000000000000000000000dfa46478f9e5ea86d57387849598dbfb2e964b020 000000000000000000000007f5c764cbc14f9669b88837ca1490cca17c316070000000000 00000000000000afea5601b0a894451955355e79ad3026515e500d000000000000000000 000000111aa81e5a37bb3586a0c1429f40eae96ec2b23600000000000000000000000000 0000000000000000000446a4a6dc2ec2e4d0000000000000000000000000000000000000 0000000000000000000004a8c69c0100000000000000000000000000000000000000000 00000000000000000000004000000000000000000000000000000000000000000000000 00000000000001400000000000000000000000000000000000000000000000000000000 00000016000000000000000000000000000000000000000000000000000000000000000 00000000000000000000000000000000000000000000000000000000000000022d00000 000000000000000000000000000000000000000000000020f0001e100a0c9e75c4800000 00000000000270b0000000000000000000000000000000000000000000000000001b300 01505106a132dab612db5cb9fc9ac426a0cc215a3423f9c9dfa46478f9e5ea86d573878495 98dbfb2e964b020004f41766d80000000000000000000000000000000000000000000000 00103c04e90000000000000000000000000000000000000000000000000000000000000 00a0000000000000000000000000afea5601b0a894451955355e79ad3026515e500d0000 00000000000000000000000000000000000000000000000000006491adcc00000000000 00000000000000000000000000000000000000000000000000001000000000000000000 000000dfa46478f9e5ea86d57387849598dbfb2e964b020000000000000000000000007f5c764cbc14f9669b88837ca1490cca17c3160700000000000000000000000000000000000 000000000000000000000000000010ca0dfa46478f9e5ea86d57387849598dbfb2e964b02c2995a065106b5c5c738b2320387460ebd12c12dc028b46d03c2995a065106b5c5c738b2 320387460ebd12c12d00000000000000000000000000000000000000000000000000000 0039937077580a06c4eca277f5c764cbc14f9669b88837ca1490cca17c316071111111254eeb25477b68fb85ed929f73a96058200000000000000000000000000000000000000e26b 9977

In this case, in an embodiment of the present disclosure, the ‘input’ field value of the currently processed transaction may be represented by being compressed into ‘#101 #11 #d597418ec4300804bf843136f01c20e4ff4f18b27b1c45f224b38a36879c026ad 94d53813f27a26d379ac4b26b8e3499dbe02e2c0760c8e6bb63ea2487d39bbd7bb277f597 2bcda465cd2dbbf721c71cd7ded29d20adc467a063ff6ca5134d239b5b6055e71d9c21939 81ae7ce5ced73abfadf13115eb902fcc99396ed48b6d0e411f496d0c8e0177a37efc77bd446 81e58df2c1ac3d4d3c0dea5f80526fb6799a78e23a49ff3ea773fb746e2eeb0f5bd61aa83a0ce6e1e9327209ec52d989505fd384f4ad6194c903509c0afafb6ac545f55db533300f2927c da00c435e3db9ef324be27455e617’. The compressed string may be obtained by executing pseudo code 1 below, in the case of Python.

### Pseudo Code 1

import zlib
co=zlib.compressobj(wbits=−zlib.MAX_WBITS, zdict=input_old)
compressed_field=co.compress(input_new)+co.flush( )

To restore the original of this field value on another blockchain node, ledger data that the node has may be searched to retrieve an ‘input’ field value (input_old) of the 11th transaction in block 101, and the value may be used to decompress the compressed string. In the case of Python, the original string may be obtained by executing pseudo code 2.

### Pseudo Code 2

import zlib
do=zlib.decompressobj(wbits=−zlib.MAX_WBITS, zdict=input_old)
original_field=do.decompress(compressed_field)

The substituted value is comprised of #(block number) #(transaction index) #(compressed string), and the other node may perform decompression using the information to restore the original data.

In an embodiment of the present disclosure, the compression method through dictionary-based substitution is described based on the use for the layer 2 transaction, but it may be equally applied to compression of the layer 1 transaction as needed.

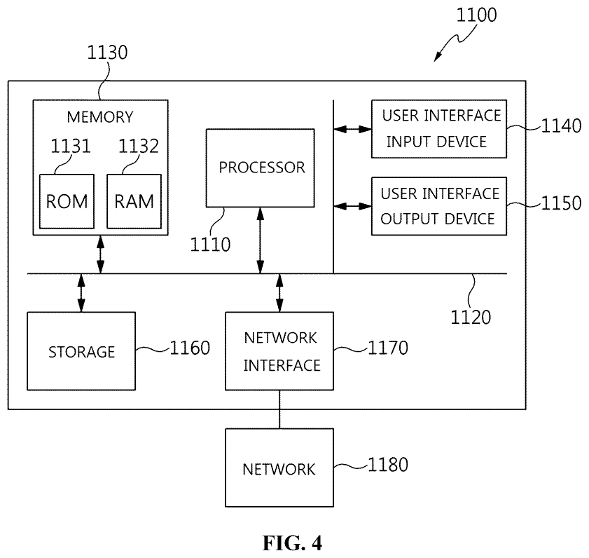

FIG. 4 illustrates a computer system according to an embodiment of the present disclosure.

Referring to FIG. 4, an apparatus for compressing blockchain rollup transaction data according to an embodiment of the present disclosure may be implemented in a computer system 1100 such as a computer-readable recording medium. As illustrated in FIG. 4, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

An apparatus for compressing blockchain rollup transaction data according to an embodiment of the present disclosure may include may include one or more processors 1110 and memory 1130 configured to store at least one program that is executed by the one or more processors 1110, wherein the at least one program is configured to group a plurality of lower layer transaction data items into a single batch on a blockchain, search pre-generated dictionary data by using a field value included in the single batch as a key, substitute the field value with an entry value searched from the dictionary data, and generate upper layer transaction data by compressing the single batch substituted with the entry value.

Here, the at least one program may be configured to, when the field value exists in the dictionary data, substitute the field value with an entry of the dictionary data, the entry including a block number and a transaction index of a transaction in which the field value previously occurred.

Here, the at least one program may be configured to, when the field value does not exist in the dictionary data, add a new entry value.

Here, the at least one program may be configured to use the field value as a key and add a value resulting from combining the transaction's block number and index as the new entry value.

Here, the at least one program may be configured to, when a ‘to’ field value exists in the dictionary data, substitute the current ‘input’ field value with a combination of a block number, a transaction index corresponding to a prior occurrence of the ‘to’ field value, and a compressed string.

Here, the at least one program may be configured to, when the ‘to’ field value of the transaction does not exist in the dictionary data, have the key as the ‘to’ field value and add the new entry, a combination of the block number, the transaction index and the ‘input’ field value.

According to the present disclosure, in blockchain rollups, when a plurality of layer 2 transactions are grouped into a batch and then submitted in the batch to the layer 1 blockchain, the batch may be further compressed to reduce the size as compared to the existing technique.

Furthermore, according to the present disclosure, effects of saving disk space, reducing transaction fees, and increasing transaction processing speed by increasing the compression ratio of transaction strings may be attained.

As described above, in the apparatus and method for compressing blockchain rollup transaction data according to the present disclosure, the configurations and schemes in the above-described embodiments are not limitedly applied, and some or all of the above embodiments can be selectively combined and configured such that various modifications are possible.

What is claimed is:

1. An apparatus for compressing blockchain rollup transaction data, comprising:
one or more processors; and
a memory configured to store at least one program that is executed by the one or more processors,
wherein the at least one program is configured to:
group a plurality of lower layer transaction data items into a single batch on blockchain,
search pre-generated dictionary data by using a field value included in the single batch as a key,
substitute the field value with an entry value searched from the dictionary data, and
generate upper layer transaction data by compressing the single batch substituted with the entry value.

2. The apparatus of claim 1, wherein the at least one program is configured to, when the field value exists in the dictionary data, substitute the field value with an entry of the dictionary data, the entry including a block number and a transaction index of a transaction in which the field value previously occurred.

3. The apparatus of claim 1, wherein the at least one program is configured to, when the field value does not exist in the dictionary data, add a new entry value.

4. The apparatus of claim 3, wherein the at least one program is configured to use the field value as a key and add a value resulting from combining the transaction's block number and index as the new entry value.

5. The apparatus of claim 2, wherein the at least one program is configured to, when a ‘to’ field value exists in the dictionary data, substitute the current ‘input’ field value with a combination of a block number, a transaction index corresponding to a prior occurrence of the ‘to’ field value, and a compressed string.

6. The apparatus of claim 3, wherein the at least one program is configured to, when no ‘to’ field value of the transaction exists in the dictionary data, add the new entry in which a key is a ‘to’ field value and a value is a combination of a block number, a transaction index and an ‘input’ field value.

7. A method for compressing blockchain rollup transaction data of an apparatus for compressing blockchain rollup transaction data, the method comprising:
grouping a plurality of lower layer transaction data items into a single batch on blockchain;
searching pre-generated dictionary data by using a field value included in the single batch as a key;
substituting the field value with an entry value searched from the dictionary data; and
generating upper layer transaction data by compressing the single batch substituted with the entry value.

8. The method of claim 7, wherein the substituting comprises, when the field value exists in the dictionary data, substituting the field value with an entry of the dictionary data, the entry including a block number and a transaction index of a transaction in which the field value previously occurred.

9. The method of claim 7, wherein the substituting comprises, when the field value does not exist in the dictionary data, add a new entry value.

10. The method of claim 9, wherein the substituting comprises using the field value and adding a value resulting from combining the transaction's block number and transaction index as the new entry value.

11. The method of claim 8, wherein the substituting comprises, when a ‘to’ field value exists in the dictionary data, substituting the current ‘input’ field value with a combination of a block number, a transaction index corresponding to a prior occurrence of the ‘to’ field value, and a compressed string.

12. The method of claim 9, wherein the substituting comprises, when no ‘to’ field value of the transaction exists in the dictionary data, adding the new entry in which a key is a ‘to’ field value and a value is a combination of a block number, a transaction index and an ‘input’ field value.
